(19) United States
(12) Patent Application Publication
(10) Pub. No.: US 2019/0246597 A1
(43) Pub. Date: Aug. 15, 2019

(54) Covered Kitty Litter Box with Spray Guard

(71) Applicant: David Awrey Randall, Springfield, MO (US)

(72) Inventor: David Awrey Randall, Springfield, MO (US)

(21) Appl. No.: 15/893,612

(22) Filed: Feb. 10, 2018

(51) Int. Cl. A01K 1/01

(52) U.S. Cl. CPC A01K 1/0107; A01K 1/011

(57) ABSTRACT

A method using material such as plastic or any other fluid-proof, easily cleaned, and hygienic material to create a vessel to contain particulate litter or other means for the collection, management, and disposal of pet excrement. An upper vessel resting atop the lower to contain and conceal the contents of the lower vessel. A vertical flange or skirt extending from the bottom of the upper vessel far enough into the lower vessel to shield the sites where these vessels abut in order to contain feline urinary spray or other waste. Said downward flange or skirt to markedly reduce internal surfaces requiring cleansing and prevents the need for cleaning outside the vessels.

### CROSS REFERENCE TO RELATED APPLICATIONS

none

### TECHNICAL FIELD

The present invention relates to systems, methods and apparatus for a pet waste/excrement receptacle with means to hide contents from view, allow easy internal access, and prevent external leakage of urinary spray

International classification: A01K 1/035; A01K 1/01; A01K 1/015;
B65D 5/60
United States classification: 119/168; 116/161; 116/165; 116/166;
116/167; 116/171; 119/165; 119/172

### FIELD OF CLASSIFICATION SEARCH

A01K 1/01; A01K 1/015; A01K 1/035; B65D 5/60
116/161; 116/165; 116/166; 116/167; 116/171; 119/165; 119/168;
119/172; 206/554; D30/161

### REFERENCES CITED

| | | |
|---|---|---|
| 2,039,783 | 1936 | Ebeling |
| 2,053,594 | 1936 | Albert |
| 2,204,416 | 1940 | Kramer |
| 2,306,014 | 1942 | Carson |
| 2,390,854 | 1945 | Thompson |
| 2,584,656 | 1948 | Anderson |
| 2,671,427 | 1954 | Fell |
| 2,741,223 | 1956 | Winborn |
| 2,883,963 | 1957 | Scott |
| 2,963,003 | 1958 | Oberg |
| 3,100,474 | 1961 | Schneider |
| 2,971,493 | 1961 | Robb |
| 3,085,550 | 1963 | Crawford |
| 3,111,932 | 1963 | Knutson |
| 3,141,441 | 1963 | Russell |
| 3,154,052 | 1964 | Sweeney |
| 3,170,618 | 1965 | Sweeney |
| 3,227,138 | 1966 | Campbell |
| 3,233,588 | 1966 | Thomas |
| 3,246,630 | 1966 | Dearing |
| 3,310,031 | 1967 | Lowe |
| 3,316,880 | 1967 | Jungles |
| 3,318,285 | 1967 | Betham |
| 3,332,397 | 1967 | Van der Wall |
| 3,339,527 | 1967 | Burroughs |
| 3,358,647 | 1967 | Wilson |
| 3,377,990 | 1968 | Mitchell |
| 3,386,417 | 1968 | Machowski |
| 3,416,495 | 1968 | Wilson |
| 3,428,026 | 1969 | Sohmers |
| 3,455,277 | 1969 | Edwards |
| 3,482,546 | 1969 | Anderson |
| 3,476,083 | 1969 | Van der Wall |
| 3,566,838 | 1971 | Edwards |
| 3,581,977 | 1971 | Kirsky |
| 3,621,817 | 1971 | Printz |
| 3,626,899 | 1971 | Spellman |
| 3,656,457 | 1972 | Houston |
| 3,684,155 | 1972 | Smith |
| 3,688,741 | 1972 | Thompson |
| 3,734,057 | 1973 | Lee |
| 3,735,735 | 1973 | Noroian |
| 3,745,975 | 1973 | Prucha |
| 3,752,120 | 1973 | Pallesi |
| 3,752,121 | 1973 | Brazzell |
| 3,757,738 | 1973 | Hall |
| 3,762,369 | 1973 | Barnum |
| 3,771,493 | 1973 | Chandor |
| 3,793,988 | 1973 | Traeger |
| 3,793,989 | 1974 | Clark |
| 3,796,188 | 1974 | Bradstreet |
| 3,818,865 | 1974 | Sinclair |
| 3,827,401 | 1974 | Franzl |
| 3,831,557 | 1974 | Elesh |
| 3,835,812 | 1974 | Edwards |
| 3,842,803 | 1974 | Temel |
| 3,871,331 | 1975 | Breau |
| 3,872,832 | 1975 | Quinn |
| 3,885,523 | 1975 | Coleman |
| 3,886,491 | 1975 | Zeitter |
| 3,890,930 | 1975 | Clark |
| 3,908,597 | 1975 | Taylor |
| 3,965,863 | 1976 | Scott |
| 3,990,396 | 1976 | Turk |
| 3,990,397 | 1976 | Lowe |
| 3,937,182 | 1976 | Kamimura |
| 3,954,086 | 1976 | Maness |
| 4,011,836 | 1977 | Temel |
| 4,014,292 | 1977 | Coughlin |
| 4,027,625 | 1977 | Wheeler |
| 4,029,048 | 1977 | Gershbein |
| 4,030,448 | 1977 | Nuttall |
| 4,047,499 | 1977 | Janecek |
| 4,050,414 | 1977 | Knochel |
| 4,090,470 | 1978 | Williams |
| 4,095,559 | 1978 | Griffith |
| 4,096,827 | 1978 | Cotter |
| 4,111,157 | 1978 | Haugen |
| 4,161,197 | 1979 | Haugen |
| 4,117,804 | 1978 | Moore |
| 4,120,264 | 1978 | Carter |
| 4,164,314 | 1979 | Edgar |
| 4,171,680 | 1979 | Silver |
| 4,190,525 | 1980 | Menzel |
| 4,196,693 | 1980 | Unversaw |
| 4,217,857 | 1980 | Geddie |
| 4,231,321 | 1980 | Cohen |
| 4,271,544 | 1981 | Hammond |
| 4,271,787 | 1981 | Wellman |
| 4,299,190 | 1981 | Rhodes |
| 4,305,544 | 1981 | Noonan |
| 4,325,325 | 1982 | Larter |
| 4,325,822 | 1982 | Miller |
| 4,327,667 | 1982 | Bilak |
| 4,348,982 | 1982 | Selby |
| 4,352,340 | 1982 | Strubelt |
| 4,359,966 | 1982 | Casino |
| 4,441,451 | 1984 | Neal |
| 4,444,148 | 1984 | Lander |
| 4,465,018 | 1984 | Mopper |
| 4,469,046 | 1984 | Yananton |
| 4,487,163 | 1984 | Jobert |
| 4,501,226 | 1985 | Bienvenu |
| 4,505,226 | 1985 | Carlson |
| 4,517,920 | 1985 | Yamamoto |
| 4,522,150 | 1985 | Gershman |
| 4,534,315 | 1985 | Sweeney |
| 4,541,360 | 1985 | Higgins |
| 4,548,160 | 1985 | Feitelson |
| 4,553,671 | 1985 | Cheesman |
| 4,493,288 | 1985 | Van der Kok |
| 4,602,593 | 1986 | Gross |
| 4,615,300 | 1986 | McDonough |
| 4,616,598 | 1986 | Burniski |
| 4,624,380 | 1986 | Wernette |
| 4,627,382 | 1986 | Muzzey |
| 4,628,863 | 1986 | Eichenauer |
| 4,640,225 | 1987 | Yananton |
| 4,646,684 | 1987 | Embry |
| 4,646,685 | 1987 | Arenz |
| 4,648,349 | 1987 | Larson |
| 4,649,862 | 1987 | Neary |
| 4,667,622 | 1987 | Breault |
| 4,696,257 | 1987 | Neary |
| 4,706,606 | 1987 | Coppola |
| 4,711,198 | 1987 | Mossbarger |
| 4,716,853 | 1988 | d'Aniello |
| 4,723,510 | 1988 | Skillestad |
| 4,724,955 | 1988 | Martin |
| 4,739,725 | 1988 | Fennelly |
| 4,760,816 | 1988 | Rhodes |
| 4,763,603 | 1988 | Coes |
| 4,766,845 | 1988 | Bavas |
| 4,771,731 | 1988 | Derx |
| 4,776,300 | 1988 | Braddock |
| 4,779,566 | 1988 | Morris |
| 4,779,567 | 1988 | Smith |
| 4,782,788 | 1988 | Arcand |
| 4,784,082 | 1988 | Wolfe |
| 4,787,335 | 1988 | Carlyn |
| 4,788,935 | 1988 | Bella |
| 4,791,883 | 1988 | Lehman |
| 4,792,082 | 1988 | Williamson |
| 4,800,841 | 1989 | Yananton |
| 4,840,140 | 1989 | Yananton |
| 4,846,103 | 1989 | Brown |
| 4,858,559 | 1989 | Allen |
| 4,870,924 | 1989 | Wolfe |
| 4,800,842 | 1989 | Jones |
| 4,801,006 | 1989 | Martin |
| 4,803,952 | 1989 | Houser |
| 4,807,563 | 1989 | Berry |
| 4,807,564 | 1989 | Soberg |
| 4,813,374 | 1989 | Sides |
| 4,813,376 | 1989 | Kaufman |
| 4,836,141 | 1989 | Whitfield |
| 4,844,011 | 1989 | Strickland |
| 4,846,105 | 1989 | Caldwell |
| 4,848,274 | 1989 | Yananton |
| 4,852,518 | 1989 | Yananton |
| 4,869,204 | 1989 | Yananton |
| 4,884,526 | 1989 | Giannakopoulis |
| 4,884,527 | 1989 | Skirvin |
| 4,886,014 | 1989 | Sheriff |
| 4,890,576 | 1990 | James |
| 4,926,794 | 1990 | Yamamoto |
| 4,940,016 | 1990 | Heath |
| 4,919,078 | 1990 | Morrison |
| 4,934,317 | 1990 | Pourschalchi |
| 4,967,692 | 1990 | Mills |
| 4,972,800 | 1990 | Bennet |
| 5,007,530 | 1991 | Weismantel |
| 5,014,649 | 1991 | Taft |
| 5,031,578 | 1991 | Hammons |
| 5,035,205 | 1991 | Schiller |
| 5,046,457 | 1991 | Ashcroft |
| 5,065,702 | 1991 | Hasiuk |
| 5,080,043 | 1992 | Fields |
| 5,080,044 | 1992 | Boxworth |
| 5,092,277 | 1992 | Bailie |
| 5,117,780 | 1992 | Wooten |
| 5,129,364 | 1992 | Pirkle |
| 5,144,914 | 1992 | Giannakopoulos |
| 5,158,042 | 1992 | Hammerslag |
| 5,167,205 | 1992 | Bell |
| 5,172,652 | 1992 | Dobrin |
| 5,184,574 | 1993 | Kirk |
| 5,193,488 | 1993 | Walton |
| 5,207,772 | 1993 | Lauretta |
| 5,211,133 | 1993 | Foley |
| 5,249,549 | 1993 | Rockaitis |
| 5,249,550 | 1993 | Hines |
| 5,361,725 | 1994 | Bailie |
| 5,367,984 | 1994 | Purnell |
| 5,394,835 | 1995 | Gatta |
| 5,482,007 | 1996 | Kumlin |
| 5,488,929 | 1996 | Pierson |
| 5,564,366 | 1996 | Hancock |
| 5,676,090 | 1997 | Cannady |
| 5,709,171 | 1998 | Moore |
| 5,758,601 | 1998 | Dickson |
| 5,983,832 | 1999 | Seo |
| 6,408,790 B1 | 2002 | Maguire |
| 2004/0011297 A1 | 2004 | Hochmann |
| 2004/0200404 A1 | 2004 | Stope |
| 2004/0261727 A1 | 2004 | Matsuo |
| 2005/0172908 A1 | 2005 | Belgiorno |
| 2005/0284392 A1 | 2005 | Hillman |
| 2006/0037548 A1 | 2006 | Mohr |
| 2006/0236949 A1 | 2006 | Hill |
| 2006/0288948 A1 | 2006 | Ikegami |
| 2007/0084413 A1 | 2007 | Oertelon |
| 2007/0113793 A1 | 2007 | Kurahashi |
| 2007/0163508 A1 | 2007 | Gloor |
| 2007/0283895 A1 | 2007 | Skovron |
| 2008/0035069 A1 | 2008 | Yamamoto |
| 2008/0178818 A1 | 2008 | Aley |
| 2008/2020440 A1 | 2008 | Stratton |
| 2009/0000556 A1 | 2009 | Matsuo |
| 2009/0000558 A1 | 2009 | Matsu |
| 2009/0000559 A1 | 2009 | Matsuo |
| 2009/0000560 A1 | 2009 | Matsuo |
| 2009/0038554 A1 | 2009 | Tsutsumi |
| 2009/0178622 A1 | 2009 | Havluciyan |
| 7,610,877 B2 | 2009 | Garfield |
| 2010/0050951 A1 | 2010 | Maguire |
| 2010/0122662 A1 | 2010 | Kennington |
| 2010/0224133 A1 | 2012 | Hiroshima |
| 2011/0067639 A1 | 2012 | Bauer |
| 2012/0006274 A1 | 2012 | Feld |
| 2012/0118241 A1 | 2012 | Smith |
| 2013/0092092 A1 | 2013 | Matsuo |
| 2013/0098300 A1 | 2013 | Matsuo |
| 2013/0098301 A1 | 2013 | Matsuo |
| 2013/0171597 A1 | 2013 | Kong |
| 2013/0213311 A1 | 2013 | Matsuo |
| 2013/0298840 A1 | 2013 | Mishan |
| 2014/0150727 A1 | 2014 | Matsuo |
| 2014/0158060 A1 | 2014 | Martin |
| 2014/0251224 A1 | 2014 | Yamamoto |
| 2015/0020743 A1 | 2015 | Bauer |
| 2015/0075439 A1 | 2015 | Abe |
| 2015/0047570 A1 | 2015 | Abe |
| 8,978,588 B2 | 2015 | Simon |
| D754,406 S | 2016 | Karsted |
| 9,737,046 B2 | 2017 | Pugh |
| 9,750,224 B2 | 2017 | Kupka |

### BACKGROUND OF INVENTION

Many people keep pets. They can be an important part of life. This is well reflected by the size of industry devoted to feeding, housing, and otherwise caring for them. Felines are among the most popular. And, while people love their cats, this sentiment is rarely extended to their kitty-litter box. Indoor cats (and their owners) depend exclusively on litter boxes or similar collecting and containment means. Even partially outdoor cats typically have access to this sort of means for their relief.

A multitude of litter boxes has been designed, patented, and produced. They range from simple pans to elaborate self-cleaning devices. While some are disposable, most employ some type of box constructed of fluid-impermeable material such as plastic. Absorbent, particulate material (cat litter) often serves to retain and cover urine and feces. Many have lids or tops to conceal their typically unattractive contents. Such a cover serves an additional, important function. Some cats spray their urine horizontally rather than allowing gravity to draw it into the bottom of the container. This results in unhygienic mess when urine escapes the confines of the litter box. It also produces frustration for the individual tasked to clean this up.

The concept for this proposed design presented itself since this inventor has the regular task of cleaning or, “scooping,” the kitty litter box. One cat periodically sprays urine and this results in external leakage. This covered box has a typical design in which the upper and lower parts are joined horizontally. The top is prevented from sliding off by a flange along periphery of its base that runs external to the upper lip of the bottom pan. This configuration allows spray to leak out between the two parts and drip down the outside. It also allows urine to collect in the surfaces where the upper and lower parts come into contact. As will be described below, this invention seeks to remedy this problem with a simple, economically-manufactured design that allows for easy access to the litter box contents while incorporating a cover that is essentially spray-proof.

### REVIEW OF PRIOR ART

A plethora of designs exists for the collection and management of animal, and particularly feline, excrement. FIGS. (1) and (2) demonstrate parts of a typical, commercially-available litter box. These are three-dimensional views of the corners of the bottom and top, respectively. The top rests upon the bottom/base in a female-on-male configuration. Contours may be seen that run parallel to the upper and lower edges/flanges where the parts abut. The base contains an approximately one-eighth inch depression into which the inner edge of the top rests. This may purportedly use gravity to discourage leakage of urine. Unfortunately, the pressure of feline spray easily forces liquid between the top and bottom and then outside of the box. Also, these linear ridges, flanges, and contours create recesses into which urine collects and increase difficulty of cleaning.

The citations above include pertinent patent literature yet reflect only a portion of inventions. All seek to minimize the unpleasantness of this aspect of pet ownership. Goals include reduction of odor, facilitating ease of removal of urine and feces, and concealment of litter box contents.

### COMPLICATED CAT LITTER BOX DESIGNS

This present invention describes a simple, efficient design. It is worth noting that review of prior art will disclose, however, that many designs are electrified or otherwise have complex mechanical functions. (U.S. Pat. Nos. 2,039,783; 2,204,416; 2,883,963; 3,227,138; 3,316,880; 3,318,285; 3,339,529; 3,428,026; 3,455,277; 3,482,546; 3,566,838; 3,621,817; 3,734,057; 3,793,988; 3,818,865; 3,835,812; 3,842,803; 3,871,331; 3,937,182; 3,954,086; 4,011,836; 4,050,414; 4,095,559; 4,096,827; 4,117,804; 4,120,264; 4,190,525; 4,196,693; 4,271,544; 4,299,190; 4,325,822; 4,327,667; 4,465,018; 4,493,288; 4,616,598; 4,667,622; 4,649,862; 4,696,257; 4,844,011; 4,886,014; 4,934,317; 5,092,277; 5,184,574; 5,193,488; 5,361,725; 5,384,835; 5,394,835; 6,408,790 B1; 9,737,046 B2; 9,750,224 B2; 2005/0284392 A1; 2006/0037548 A1; 2007/0163508 A1)

Edwards described a dedicated, plumbed-in commode for animals. (U.S. Pat. No. 3,835,812) Automatic irrigation has been used in some designs to rinse away or collect waste. (U.S. Pat. Nos. 2,204,416; 2,883,963; 3,227,138; 3,318,285; 3,734,057; 3,762,369; 3,835,812; 3,842,803; 4,011,836; 4,050,414; 2005/0284392 A1; 2010/0122662 A1) Several patents have been granted for inventions that allow a pet to relieve itself at a standard human toilet. (U.S. Pat. Nos. 2,053,594; 2,584,656; 3,656,457; 3,757,738; 4,231,321; 5,117,780). Some use various mechanical means to remove excrement. Others sift, discard, and/or and replace litter. (U.S. Pat. Nos. 3,621,817; 4,096,827; 4,120,264; 4,190,525; 4,493,228; 4,522,150; 4,616,598; 4,667,622; 4,934,317; 5,394,835) A number incorporate a conveyor-belt mechanism to carry material to a container for disposal. (U.S. Pat. Nos. 3,793,988; 3,871,331; 3,937,182; 4,050,414; 4,196,693; 4,465, 018; 4,844,011; 9,737,046 B2)

The majority of the citations above use cat litter to collect and deodorize material and allow the cat to bury solid waste. A lesser number have drains or other perforations to allow excrement to drop into a collecting receptacle beneath the surface upon which the animal relieves itself. (U.S. Pat. Nos. 2,306,014; 2,390,854; 4,050,414; 4,271,544; 2007/0283895 A1; 2010/005095 A1; 2013/0092092 A1; 2013/0098300 A1; 2013/0098301 A1; 2013/0213311 A1). The Griffith box incorporates a ventilation exhaust system to carry odors out-of-doors. In testimony to our desire to encourage our animals, another may be programmed to offer verbal praise upon use of the device (2013/0171597) Furniture as well has been designed to conceal pet waste containers (3,8787,832)

The paucity of the above patents brought to market suggests their infeasibility due to cost and complexity. Despite the typical pet owners disdain for, “poop-scooping,” the use of absorbent, particulate matter (cat or kitty litter) provides an economical, simple, and popular means to contain excrement. Goals in designing a satisfactory litter box may include:
1. Economical design
2. Ease of manufacture
3. Good internal access for sifting or scooping the litter
4. Prevention of feline urinary spray and other material escaping the vessel
5. Minimized internal surfaces that must be cleaned after spraying
6. Provision of a cover for concealment and containment of excrement

The focus of this present invention is production of an inexpensive device that avoids complicated mechanical or other superfluous functions. This may be accomplished with either disposable or reusable vessels.

Disposable Litter Boxes

Some patents describe disposable litter boxes-either covered or uncovered. The majority lack covers. (U.S. Pat. Nos. 3,154,052; 3,170,618; 3,581,977; 3,745,975; 3,386,491; 4,014,292; 4,164,314; 4,170,680; 4,271,787; 4,348,982; 4,441,451; 4,541,360; 4,548,160; 4,553,671; 4,624,380; 4,627,382; 4,628,863; 4,706,606; 4,763,603; 4,776,300; 4,779,566; 4,779,567; 4,782,788; 4,784,082; 4,788,935; 4,791,883; 4,800,841; 4,810,006; 4,807,563; 4,807,564; 4,846,103; 4,846,105; 4,870,924; 4,884,527; 4,919,078; 4,696,692; 5,007,530; 5,035,205; 5,046,457; 5,065,702; 5,080,043′ 5,080,044; 5,144,914; 5,167,205; 5,172,652; 5,249,549; 5,249,550; 5,482,007; 5,709,171; 5,758,601; 2004/0200424 A1; 2012/0006274 A1) Several incorporate covers or lids to hid contents. (U.S. Pat. Nos. 4,348,982; 4,792,082; 4,940,016; 5,129,365)

These seek to facilitate litter management by avoiding the need for periodic emptying and washing of a permanent box. A number include prepackaged litter. They have a number of disadvantages. Both the container and litter are discarded, which increases waste sent to landfills. The container materials may be more liquid-permeable and prone to leakage. Convenience comes at a cost. Such designs will be inherently more expensive than the purchase of bulk cat litter. Many disposable designs require user assembly and can be fairly complex.

Disposable uncovered boxes have the same issue of containment of urinary spray. Incorporation of higher sides may address this issue at the cost of forcing the user to reach down further, making scooping less ergonomic. They also fail to hide the untidy appearance of the litter. Those that incorporate a top portion can impair access to their contents. Boxes of plastic or similar material usually have a lid that may be easily removed, making it easy to reach all parts of the container. Disposable, covered boxes generally lack this convenient feature. Below are described some drawbacks of disposable, covered litter boxes.
1. Selby 1982 (U.S. Pat. No. 4,348,982) This illustrates both house and carton-shaped covered embodiments. An internal pan holds litter. Although the walls of the enclosure prevent urinary spray escape, it will collect between the pan and the enclosure. Further, the pet owner must reach well down into the vessel to sift litter or remove the internal pan. This incurs likely contact between the hands and excrement-contaminated internal walls.
2. Williamson 1988 (U.S. Pat. No. 4,792,082) The container offers the same access challenges as Selby in that the pet owner must reach in from above or from the front to access box contents as evidenced Is FIG. (1). Williamson's FIG. (2) suggests that the vertical corners lack connection which would allow leakage of spray. FIG. (4) shows an embodiment wherein neither the front nor back offers spray resistance.
3. Heath 1990 (U.S. Pat. No. 4,940,016) This vessel appears to share the same limitation of access for litter-sifting as with the above. Its FIGS. (3) and (4) suggest some complexity in its assembly.
4. Pirkle 1992 (U.S. Pat. No. 5,129,365) suffers from the same issues of internal access and assembly required.

Uncovered Non-Disposable Litter Doxes

The simplest design involves some type of pan or uncovered box. Unfortunately, all these share the same leakage and containment problems regardless of the internal means to collect excrement. Some have elevated side walls that may or may not prevent urine spray mess outside the vessel. (U.S. Pat. Nos. 2,791,493; 3,141,441; 3,310,031; 3,476,083; 3,734,057; 3,771,493; 3,831,557; 3,842,803; 4,014,292; 4,030,448; 4,469,046; 4,484,274; 4,505,226; 4,624,380; 4,628,863; 4,640,225; 4,646,685; 4,766,845; 2004/0261727 A1; 2005/0284392 A1; 2005/0288948 A1; 2006/0037548 A1; 2009/0000558 A1; 2009/0178622 A1; 2010/0050951; 2014/0150727 A1) Unfortunately, higher sides require that the user reach down further into the box which compromises ergonomics and makes hand contact with excrement more likely.

Side Curtains/Walls that Attach to Uncovered Boxes

Aley (2008/0178818 A1) described a device similar to the side walls of a tent. His FIG. (1) demonstrates its means of attachment to the top of an uncovered box. The walls reside beyond the confines of the vessel beneath. Urinary spray would collect on the sidewall material and drip down onto the external aspect of the box and onto the floor or surface beneath. The material is described as absorbent but would saturate at some point. The pet owner would then face the unpleasant task of managing this excrement-soaked material. Multiple configurations of supports would be needed to fit the given the varying dimensions and shapes of the upper edges of litter boxes.

Garfield (U.S. Pat. No. 7,610,877 B2) patented a similar concept to that of Aley yet drapes inside the vessel for better excrement collection. Various embodiments are described. Some use fabric for the side walls while others use solid sides or a liner extending down into the box. Like the Aley design, the user has the periodic issue of cleaning either a cloth device or one comprised of multiple parts. Neither conceals the box contents. Again, varying shapes of attachment means would be required. Finally, both Aley and Garfield designs require purchase and installation of a separate, additional product to accomplish functions that could have been easily designed integral to the litter box itself.

Covered Non-Disposable Boxes

Many patents and commercial products incorporate a lid or upper portion. (U.S. Pat. Nos. 3,085,550; 3,246,630; 3,339,529; 3,428,026; 3,752,120; 3,793,989; 3,818,865; 3,871,331; 3,885,52; 3,890,930; 3,890,930 4,029,048; 4,111,147; 4,161,157; 4,299,190; 4,327,667; 4,465,018; 4,522,150; 4,616,598; 4,696,257; 4,760,816; 4,787,335; 4,800,842; 4,803,952; 5,014,649; 5,092,277; 5,211,133; 5,394,835; 5,676,090; 2009/0000556 A1; 2009/0000559 A1; 2009/0000560 A1; 2011/0067639 A1; 2015/0020743 A1; 2015/0075439 A1) This offers the potential for containment of waste and spray.

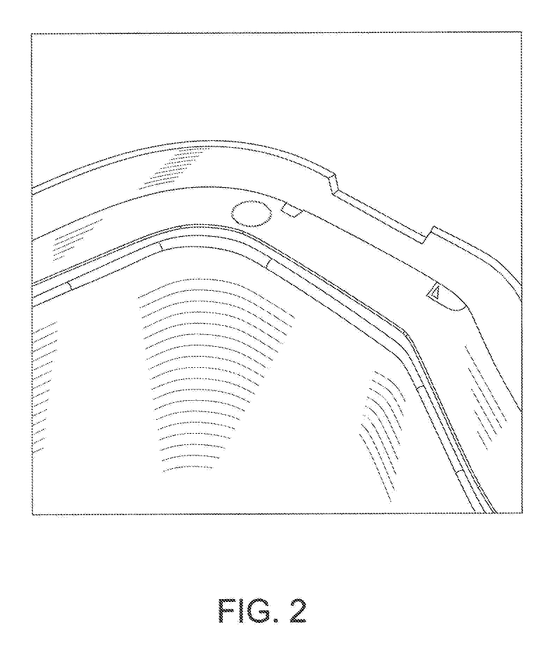

Some reflect designs commonly encountered by the pet owner while others to not. The latter, uncommon methods shall be discussed with their attendant drawbacks.
1. Kramer 1940 (U.S. Pat. No. 2,204,416) designed a complicated self-rinsing device. However, sprayed urine would collect on the inside of the enclosure, leak under the pan, and present a challenge to wash.
2. Crawford 1963 (U.S. Pat. No. 3,085,550) described a low litter pan. A box encloses it from above and rests outside the pan on the floor. Examination of its FIG. (1) shows that sprayed urine would collect between the pan and covering box (requiring both abutting surfaces to be cleaned) and leak onto the floor and seep under the pan. The front lacks any protection.
3. Pallesi 1973 (U.S. Pat. No. 3,752,120) places an enclosure around a low pan that offers no spray protection with drawbacks as mentioned in Crawford 1963.
4. Dearing 1966 (U.S. Pat. No. 3,246,630) depicts a covered box similar to those commercially available. His FIGS. (2)-(4) illustrate how urine can leak out and leave several mating edges to be cleaned.
5. Anderson 1967 (U.S. Pat. No. 3,482,546) describes a relatively complex design without cat litter. Access through the front or between the high sides would be a challenge for washing.
6. Sohmers 1969 (U.S. Pat. No. 3,428,026) places the lid within the bottom which may discourage leakage in his FIGS. (1)-(2). However, spray would drip down sides (26) and onto and beneath internal flanges (22) and (24) as well as around vertical post (26)/(30) as well as where the top and bottom mate to make cleaning more difficult. Its FIG. (6) shows an alternative design that would leak urine between parts (20) and (114) as well as present a challenge cleaning the accordion type internal structures.
7. Clark 1974 (U.S. Pat. No. 3,793,989) would allow spray to collect between the internal and external bases, beneath the internal pan, and down the lower, internal aspects of the cover to reach the floor and seep beneath the external bottom pan.
8. Coleman 1975 (U.S. Pat. No. 3,885,523) has a more complicated design incorporating a paw-cleaning grate. The lid does fit into the base though forceful spray might escape. Any spray would seep between the contours of the lid and the shelf of the base that supports it making removal of dried urine more difficult.
9. Strubelt 1982 (U.S. Pat. No. 4,352,340) modifies a small trash can with a lid to incorporate an entrance into the side. This requires the user to reach down into the vessel for scooping as well as the need to use of a custom sack liner specific for this device.
10. Gershbein's 1997 (U.S. Pat. No. 4,029,048) has an internal pan in an external box/cover. Urine would drip down the insides of the cover and collect between it and the litter pan as well as beneath the litter pan.
11. Haugen 1978 (U.S. Pat. No. 4,111,157) inserts a flange from the top into the bottom to possibly discourage spray. The cover-page cross section and its FIG. (2) demonstrate the limited vertical extent of this flange. Urine could escape, however, beneath it. The contouring of parts (22), (24-26), (37) and (40) suggests that multiple surfaces would require cleansing with urinary leakage.
12. Haugen 1979 (U.S. Pat. No. 4,161,157) appears to have the same leakage risk as in U.S. Pat. No. 4,111,157 as illustrated in FIGS. (1) and (2) of this patent. The outer lip of the top flange rests external to the flange of the base and would allow escape of waste.
13. Neary 1987 (U.S. Pat. No. 4,696,257) describes a device similar to the Haugen deisgns. His FIG. (2) demonstrates the same propensity to leak urinary spray to the outside.
14. Carlyon 1988 (U.S. Pat. No. 4,787,335) incorporates a, “pup-tent,” or, “A-frame,” enclosure around a litter pan that would collect urine between its interior and along the exterior and bottom of said enclosed pan. It offers no spray protection in front or back.
15. Jones 1989 (U.S. Pat. No. 4,800,842) describes a complicated, collapsing structure that would discourage external spray. The lid configuration inhibits easy access to the interior and cannot be as easily placed back into position as other designs.
16. Houser 1989 (U.S. Pat. No. 4,803,952) patented a two-level pet condominium with a covered litter box on bottom. This requires complicated assembly of multiple parts as demonstrated in FIGS. 2-8. It appears to have propensity for urinary leakage.
17. Foley 1993 (U.S. Pat. No. 5,211,133) incorporates a similar top and bottom flange arrangement as illustrated in this patent's FIGS. (1) and (2) that allow spray leakage.
18. Cannady 1997 (U.S. Pat. No. 5,676,090) has a top resting on the bottom without any flange to discourage exit of urine.
19. Karsted 2016 (U.S. Pat. No. D754,406S) places the top within the bottom but has a shallow vertical flange height that would likely not contain spray. It would also require cleaning of the two abutting L-shaped contours where the top and bottom join,
20. Bauer 2011 (2011/00667639 A1) and 2015 (2015/0020743) suffer from the same flange positioning and potential leakage issue described in FIGS. (1) and (2) of my presently proposed patent.
21. The following Matsuo designs share the same drawbacks as illustrated in Bauer above: 2009/0000556 A1; 2009/0000559 A1; 2009/0000560 A1

Designs typically have a lower box with sides extending upward around five or six inches. An outward-extending flange comprises the upper edge of these sides. On top of this sits the cover or upper portion that mates with its own correspondingly contoured flange. The bottom flange fits within the margins of its partner on top to create an aesthetic and tidy appearance. This also prevents the top from sliding off. Unfortunately, the height of this junction between the two parts approximates that of the animal's excretory orifi, which can facilitate leakages of spray and other material.

FIGS. (1) and (2) herein illustrate the flange configurations of, respectively, the bottom and top of a common, commercially available box. The shallow depression in the lower edge appears to offer resistance to spray leakage but, in fact, does not.

Several patents reverse the male to female orientation such that the top inserts into the bottom. Jones (U.S. Pat. No. 4,800,842) has a collapsing top portion extending down to the base of the bottom. It lacks the convenience of a top that may be easily removed and replaced. This results in more difficulty reaching the back of the container. The Karsted design patent (U.S. Pat. No. D754,406 S) has matching flanges but their low height is such that urine might leak or wick out. This configuration requires that the user must clean both L-shaped mating surfaces in addition to the inside of the container. Coleman (U.S. Pat. No. 3,885,523) has the upper box resting on an internal flange in the lower. This appears more resistant to external leakage but still requires that after spray, the owner has several contacting surfaces to clean. Sohmers' device (U.S. Pat. No. 3,428,026) has similar issues to Coleman but is worse with regard to wiping down the area where the upper and lower parts contact due to increased parts where they join. Embry (U.S. Pat. No. 4,646,684) has a more prominent internal flange on the raised but has a much more complicated hinged design and uses an internal liner. It lacks a cover.

### LEGEND OF PARTS OF FIGURES

51. Top of litter box

52. Bottom of litter box

53. Flange at lower aspect of litter box top that abuts flange (54) of bottom

54. Flange at upper aspect of litter box bottom that abuts flange (53) of top

55. Opening entrance for pet access at front of litter box

56. Spray guard flange on lower aspect of litter box top that inserts into bottom

57. Handle of litter scoop

58. Shaft of litter scoop

59. Sieve or sifting portion of litter scoop

### LIST OF FIGURES

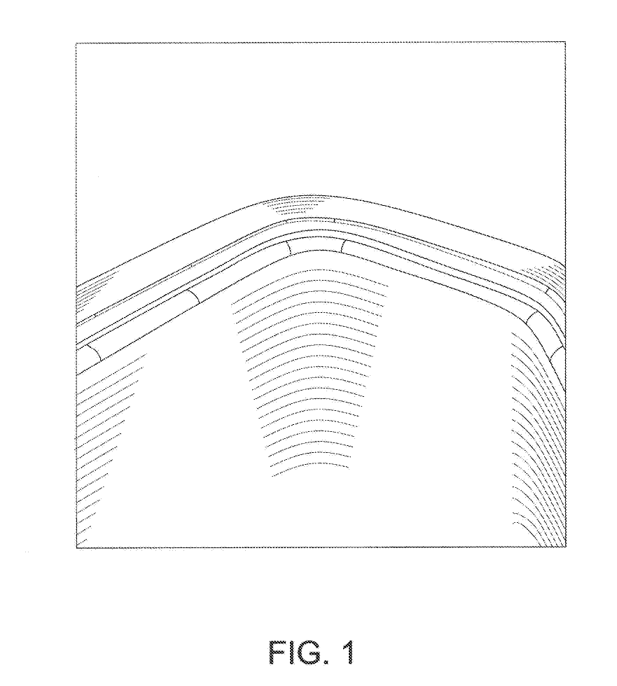

FIG. 1. Three-dimensional view of corner of upper flange on cat litter box base (contacts and rests beneath the flange in FIG. 2)

FIG. 2. Three-dimensional view of corner of bottom flange of cat litter box top (where it rests upon/contacts the flange in FIG. 1)

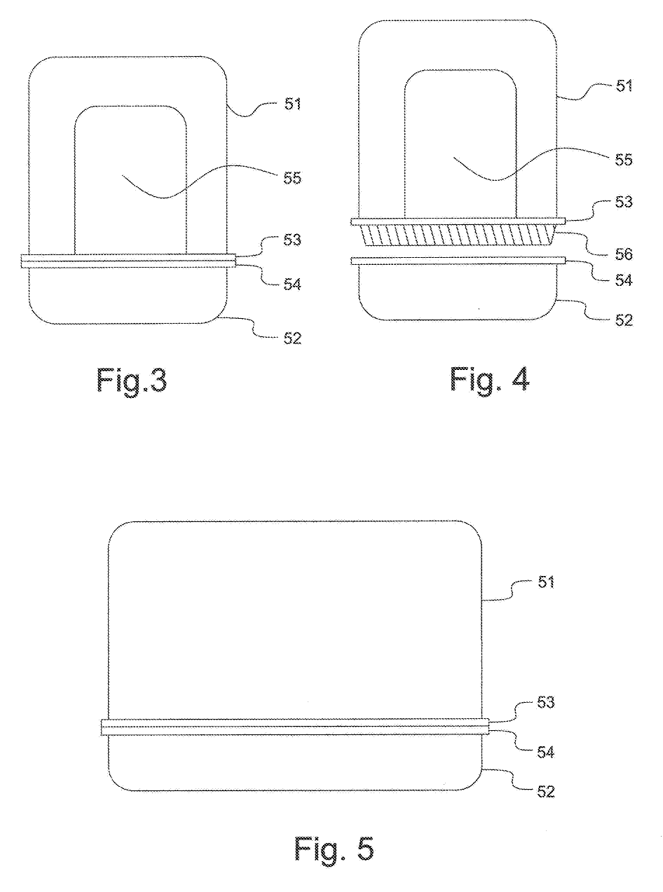

FIG. 3. Front of litter box with top in place on bottom

FIG. 4. Front of litter box with top raised above and out of bottom

FIG. 5. Side of litter box with top in place on bottom

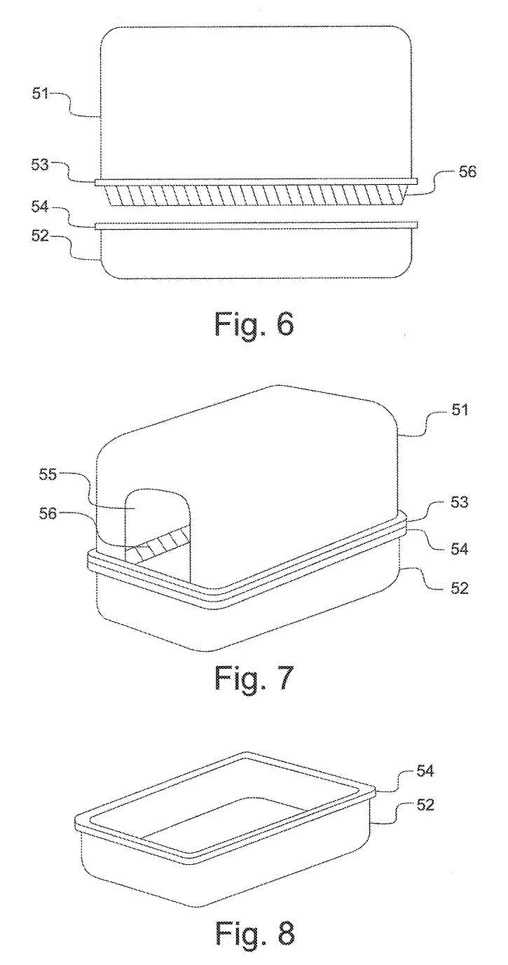

FIG. 6. Side of litter box with top raised above and out of bottom

FIG. 7. Three-dimensional view of litter box with top in place on bottom

FIG. 8. Three-dimensional view of bottom of litter box

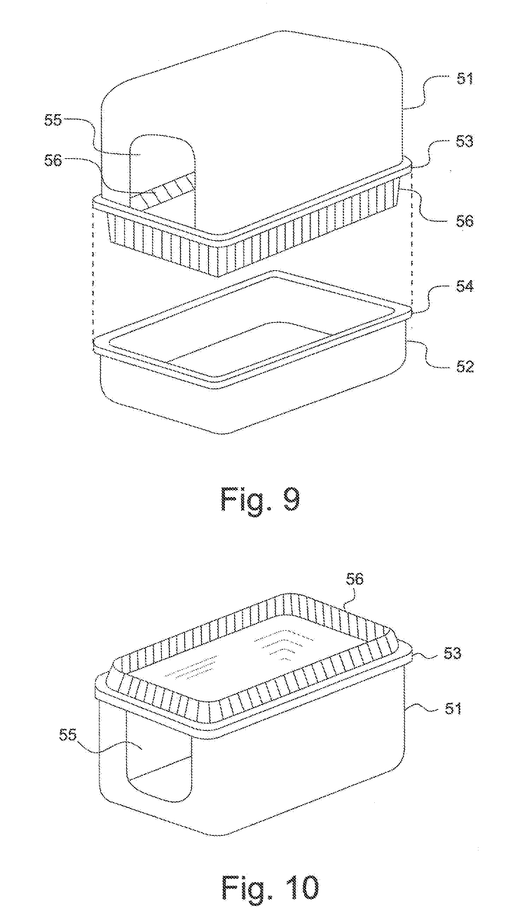

FIG. 9. Three-dimensional view of top raised above and out of bottom

FIG. 10. Three-dimensional view of top of litter box upside-down

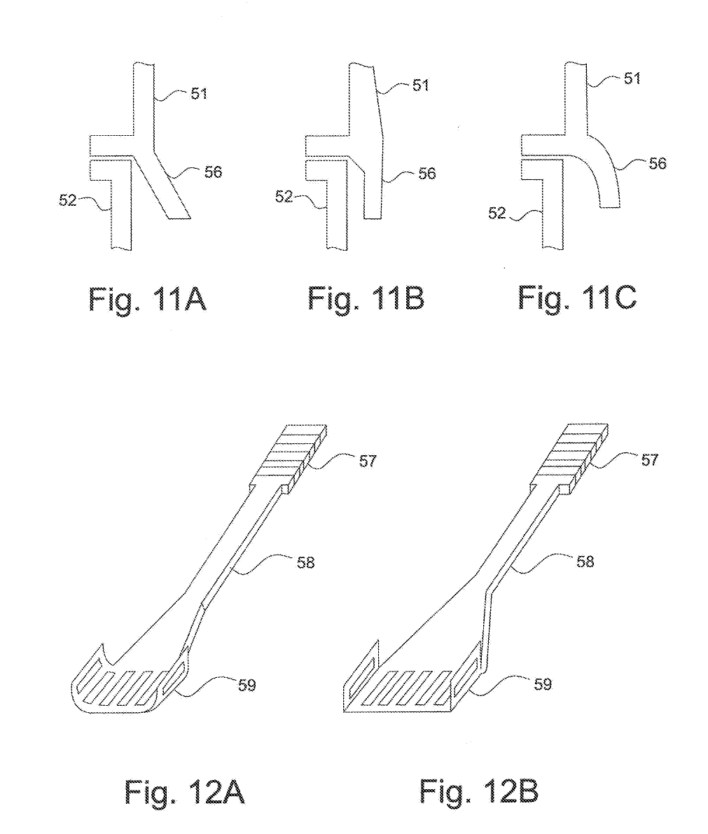

FIG. 11A. Cross sectional detail of where top and bottom meet with angled spray flange

FIG. 11B. Cross sectional detail of where top and bottom meet with vertical flange

FIG. 11C. Cross sectional detail of where top and bottom meet with curved flange

FIG. 12A. Three-dimensional view of curved edge litter scoop

FIG. 12B. Three-dimensional view of right angle edge litter scoop

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system, a method, and apparatus to facilitate the hygienic containment and concealment of pet excrement. It further seeks to simplify required cleaning of waste from its parts. Additionally, offers the ability to simply and ergonomically collect excreta, litter, and other materials for transfer to other vessels. Those skilled in the art will recognize that this design may be easily and economically fabricated by manufacture methods presently in existence.

Use of this Litter Box
1. FIG. 7 depicts the litter box in its normal configuration. The top (51) rests on the base/bottom (52).
2. FIG. 9 depicts the top (51) being lifted off the bottom (52) which allows access for sifting and otherwise cleaning the litter and excrement contents within the bottom (52)
3. FIG. 9 also depicts the downward flange (56) (hereinafter referred to as the spray guard) extending beneath the lower aspect of the top (51) and its flange (53). Said spray guard (56) prevents urinary spray from reaching the space between flanges (53) and (54). This flange also keeps the top (51) seated on the base (52)
4. FIGS. 11A, 11B, and 11C show that the spray guard (56) resides internal to the base (52) and its flange (54) and extends inferiorly enough to prevent urine to reach the space between flanges (53) and (54). The spray guard (56) is positioned inwardly from the parts (52) and (54) to allow urine to drip down into the litter beneath.
5. The configuration described above limits the areas requiring wiping of urine and excrement to the internal faces of parts (51), (52), and (56), greatly simplifying the task of cleansing and keeping hygienic the litter box.
6. FIGS. (12A) and (12B) illustrated modifications of lifter-scooping/sifting implements whose lower edges match internal contours where the sides and bottoms of the base (52) meet to increase efficiency of excrement removal.

Summary of Advantages Over Prior Art

The various embodiments of this invention provide solutions to difficulties with convenience, hygiene, and appearance of the pet litter box encountered in previous products and patents.
1. It avoids unnecessarily complicated design and may be economically and easily manufactured with use of existing art.
2. Litter box contents remain concealed in unlike with the multiple designs that lack a cover.
3. The spray guard may be easily incoporated into excrement container devices that use standard litter or those that use other methods of collection.
4. The spray guard may be used in disposable as well as non-disposable boxes
5. This design minimizes surfaces exposed to excrement and spray that require cleaning. It has no complicated abutting flanges such as in FIGS. (1) and (2) that can retain urine and odor and impair cleaning.
6. Handles, devices to hold the top and bottom together, ornamentation and other features may be easily added in alternate embodiments
7. Existing litter boxes may be retrofitted with a top that incorporates a spray guard (56) to improve their function and cleanliness.

It should be understood, of course, that the foregoing relates to exemplary embodiments of the invention and that modifications may be made without departing from the spirit and scope of the invention as set forth in the following claims.

What is claimed is:

1. An apparatus comprising:
a pair of opposing vessels wherein the upper rests upon the lower during normal use with mating flanges stabilizing the upper on the lower;
ease of separation of the opposing vessels for purposes of internal access while preventing or limiting drippage or mess to their external aspects;
said lower vessel comprising a fluid-proof container to retain cat litter or any other means for collection of pet waste;
an upper vessel of fluid-proof material resting atop the lower to conceal and facilitate containment of lower vessel contents;
said upper vessel to incorporate an opening or other means to allow the pet to gain access to the interior;
further, said upper vessel to incorporate an internal downward flange or other means at its lower aspect to prevent escape of urine or other waste;
said flange to insert downward and within the walls of the lower vessel to limit the extent of surface area of the vessels contaminated by urinary spray or other waste, thereby reducing cleansing effort required after such a spray event;
Simplicity of design to facilitate ease of manufacture by existing processes known to those skilled in the art;
Potential alternate embodiments to incorporate handles, locking features between the vessels, designs of ornamentation, and various means of excrement management, and/or disposable or alternate materials.
